(19) United States
(12) Patent Application Publication
(10) Pub. No.: US 2026/0351833 A1
(43) Pub. Date: Nov. 5, 2026

(54) ONBOARD UNIT FOR A WIRELESS VEHICLE IDENTIFICATION SYSTEM

(71) Applicant: Kapsch TrafficCom AG, Wien (AT)

(72) Inventor: Stefan SCHIDL, Wien (AT)

(21) Appl. No.: 19/478,154

(22) PCT Filed: Mar. 6, 2024
(86) PCT No.: PCT/EP2024/055868

§ 371 Date: Oct. 23, 2025

(30) Foreign Application Priority Data
Apr. 26, 2023 (EP) 23170058.4

(51) Int. Cl. H01Q 1/12; B60R 11/00; G06K 19/077; H01Q 1/42; H01Q 9/04

(52) U.S. Cl. CPC H01Q 1/1271; B60R 11/00; G06K 19/07758; H01Q 1/42; H01Q 9/0407; B60R 2011/0056; B60R 2011/0063

(57) ABSTRACT

An onboard unit for wireless communication with a vehicle identification system via radio waves comprises a housing with a front side and a rear side and a circuit board therein, an antenna connected to the circuit board and arranged in the housing near the front side, and a solar cell supported by the housing near the rear side, powering the circuit board and having a photosensitive side and an electrically conductive layer, the photosensitive side being visible from outside the housing, wherein the antenna is arranged at a distance from the electrically conductive layer of the solar cell such that radio waves penetrating the front side interfere at the antenna with radio waves reflected by the electrically conductive layer.

### CROSS-REFERENCE TO RELATED APPLICATIONS

This application is a National Phase application of International Application No. PCT/EP2024/055868 filed Mar. 6, 2024 which claims priority to the European Patent Application No. 23 170 058.4 filed Apr. 26, 2023, the disclosures of which are incorporated herein by reference.

### TECHNICAL FIELD

The present disclosed subject matter relates to an onboard unit for wireless communication with a vehicle identification system, in particular a road toll, parking space management or access system, via radio waves.

### BACKGROUND

Onboard units (OBUs) of this type use a wide variety of short range communication standards for wireless communication such as DSRC (Dedicated Short Range Communication), in particular CEN-DSRC, ETSI ITS-G 5, WAVE, WLAN (in particular IEEE 802.11x), RFID, NFC etc. Radio waves around 5.8 GHz or 5.9 GHz are commonly used, yielding wave lengths of about 5 cm.

The onboard units typically have a battery-powered transponder with an antenna for this sort of wireless communication. Recently, solar-powered onboard units have been proposed to extend the battery life or get rid of the battery at all, see, e.g., CN 203567522 U, CN 105469610 A, CN 209730882 U, CN 110751739 A or US 2012/0234922 A1.

### BRIEF SUMMARY

It is an object of the disclosed subject matter to improve solar-powered onboard units with respect to their wireless communication capabilities.

This object is achieved by means of an onboard unit for wireless communication with a vehicle identification system via radio waves, comprising:
a housing with a front side and a rear side and a circuit board in the housing,
an antenna for radio waves which is connected to the circuit board and arranged in the housing near the front side, and
a solar cell supported by the housing near the rear side, powering the circuit board and having a photosensitive side and an electrically conductive layer, the photosensitive side being visible from outside the housing,
wherein the antenna is arranged at a distance from the electrically conductive layer of the solar cell such that radio waves penetrating the front side interfere at the antenna with radio waves reflected by the electrically conductive layer.

The onboard unit of the disclosed subject matter uses the electrically conductive layer of the solar cell as a reflector for the radio waves of the antenna, not only to avoid loosing radio power towards the solar cell but to use it as additional steering radio power for communication. The electrically conductive layer of the solar cell redirects the radio waves towards the antenna, improving the antenna gain in a selected direction. For example, when the distance is chosen such that the radio waves penetrating the front side constructively interfere at the antenna with the radio waves reflected by the electrically conductive layer, the antenna gain in a direction normal to the extension of the antenna is increased. Alternatively, if the distance is chosen such that the radio waves penetrating the front side destructively interfere at the antenna with radio waves reflected by the electrically conductive layer, the antenna gain in side lobes off the normal direction is increased.

The disclosed onboard unit has thus two distinctive sides, a front side with an antenna for improved radio communication and a rear side with a solar cell exclusively for powering. The front side can face the vehicle's identification system, e.g., radio beacons along or across the road, while the rear side can face the ambient light in the vehicle interior to energise the solar cell. In effect, a solar-powered onboard unit with improved radio communication is provided.

Optionally, the distance of the electrically conductive layer of the solar cell to the antenna is an integer multiple of half the wavelength of the center frequency of the radio waves, optimising constructive interference in a given frequency band.

The electrically conductive layer of the solar cell can be any type, e.g., a grid or mesh of wires across the photosensitive side of the cell (“front-contacted solar cell”) or, in case of a rear-contacted solar cell, a continuous sheet or coating of conductive material across its rear side. In case of a grid or mesh the holes of the grid or mesh should, of course, be significantly smaller than the wavelength of the radio waves.

In front-contacted solar cells the electrically conductive layer of the solar cell might even face away from the antenna. Alternatively, however, the electrically conductive layer faces the antenna to avoid attenuation of the reflected radio waves used for constructive interference.

According to an optional feature of the disclosed subject matter the antenna is a patch antenna parallel to the electrically conductive layer. The distance between the antenna and the electrically conductive layer will then be constant and can be easily calculated.

In all embodiments the front side of the onboard unit may optionally be provided with an adhesive strip or a suction cup for attaching the housing to a windscreen of a vehicle. The onboard unit's rear side with the solar cell will then face the vehicle's interior and gather the ambient light in the vehicle, while the front side with the antenna can be turned to roadside equipment of the vehicle identification system.

### BRIEF DESCRIPTION OF THE DRAWINGS

The disclosed subject matter will now be described in further detail by means of an exemplary embodiment thereof under reference to the enclosed drawing, in which show:

FIG. 1 the onboard unit of the disclosed subject matter in a rear view;

FIG. 2 the onboard unit of the disclosed subject matter in a sectional view according to the section II-II in FIG. 1; and

FIG. 3 an exemplary patch antenna for the onboard unit of FIGS. 1 and 2 in an exploded perspective view.

### DETAILED DESCRIPTION

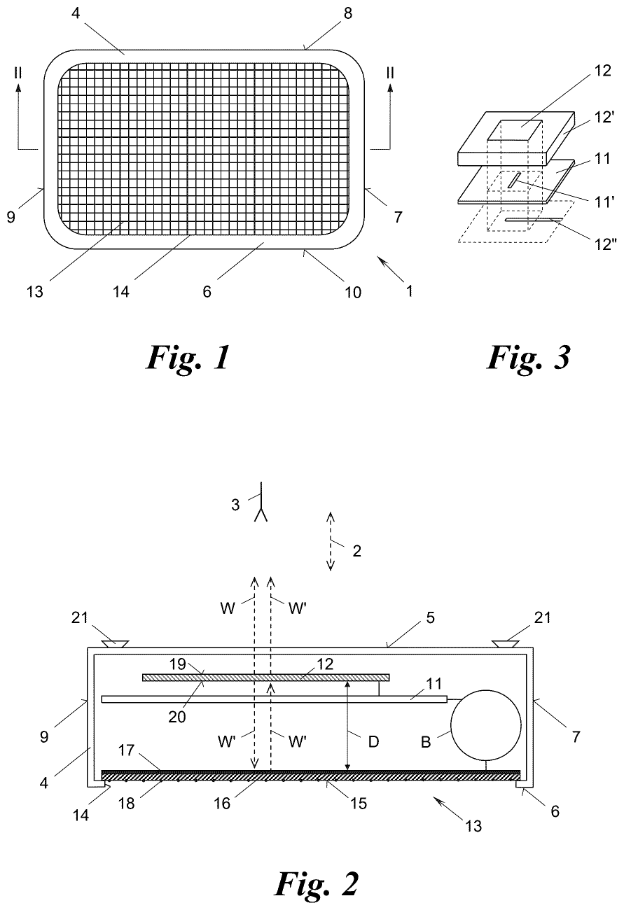

FIGS. 1 and 2 show an onboard unit 1 for wireless communication 2 via radio waves with a (symbolically depicted) vehicle identification system 3. The onboard unit 1 may be installed on any sort of vehicle, e.g., a car, truck, train, ship, aircraft etc. The vehicle identification system 3 can be any system which requires a vehicle to be identified, e.g., a road toll system (electronic toll collection system, ETCS), a parking space management system, an access system for restricted areas like cities, country borders etc., a management system for shunting yards, airports aprons, gates for ships, or the like.

The wireless communication 2 between the onboard unit 1 and the system 3 can be based on any short range communication standard, e.g., a DSRC standard according to CEN, UNI or ETSI ITS-G 5, a WAVE standard according to IEEE 802.11x, a WLAN, RFID, NFC or Bluetooth standard or the like. In the present example the onboard unit 1 is a DSRC OBU for an ETCS, and the wireless communication 2 operates in frequency bands around center frequencies of 5.8 GHz or 5.9 GHZ, respectively, equivalent to a wavelength λ of about 5 cm.

The onboard unit 1 has a housing 4 in the form of a small flat box with a front side 5, a rear side 6 and four lateral sides 7-10. The housing 4 can have any shape and size as long as it has two opposite sides of which one can serve as a front side 5 and another one can serve as a rear side 6.

The housing 4 protects and mounts a circuit board 11, e.g., a printed circuit board (PCB), with all the electronics that form an active or passive transponder for the wireless communication 2 with the system 3. An antenna 12 is electrically connected to the circuit board 11. The antenna 12 will in most cases be a patch antenna, i.e., an antenna extending in two dimensions. The antenna 12 may lie parallel to the front side 5 of the housing 4 to save space. For optimum communication the antenna 12 can be nearly as large as the entire front side 5. The antenna 12 is near the front side 5 of the housing 4 and may be supported by the circuit board 11 and/or the housing 4.

FIG. 3 shows an example of an aperture-coupled patch antenna 12 in form of a metallic layer on a substrate 12′ attached to the front (here: top) side of the circuit board 11. The circuit board 11 has a slot going through from its front to its rear (here: bottom) side, where a microstrip connector 12″ is used to couple a high frequency signal through the slot 11′ into the patch antenna 12 for emission as radio waves.

The circuit board 11 is powered by a solar cell 13 either directly or via a rechargeable battery B as an energy buffer. The solar cell 13 is supported by the housing 4 near the rear side 6 of the housing 4. The solar cell 13 can be applied onto the rear side 6 of the housing 4. Alternatively, the solar cell 13 can be installed in the housing 4 behind a window 14 in the rear side 6 that leaves at least the photosensitive side 15 of the solar cell 13 visible from outside the housing 4. The window 14 can be closed by a transparent cover or be left open.

The solar cell 13 can be of any known type, e.g., crystalline or amorphous, rigid or flexible. The solar cell 13 has a photovoltaic layer 16 converting light energy impinging on its photosensitive side 15 into electric energy. To this end the photovoltaic layer 16 is contacted by at least one electrically conductive layer 17. In some cases the electrically conductive layer 17 will be a continuous sheet or coating of conductive material on the side of the solar cell 13 that faces away from its photosensitive side 15, while a grid or mesh of wires 18 at the photosensitive side 15 serves as an opposite electrode for the photovoltaic layer 16. The electrically conductive layer 17 may, however, itself be a grid or mesh of wires or conductors, for example in front-contacted solar cells. Generally speaking the solar cell 13 has at least one electrically conductive layer 17 co-extending with its photosensitive side 15 that is either a continuous conductive sheet or coating or at least a grid or mesh of electrical conductors with a spacing significantly smaller than the wavelength λ so that it acts very much like a continous electrically conductive layer for that wavelength.

The antenna 12 is arranged at a distance D from the electrically conductive layer 17 of the solar cell 13. In the present example the antenna 12 is parallel to the electrically conductive layer 17 so that the distance D is constant over the extension of the antenna 12, although different profiles of the distance D may be suited for different types of antennas 12. The antenna 12 and the electrically conductive layer 17 may thus not necessarily be planar as shown but could also be curved, e.g., in parallel.

The distance D—which includes here also the averaged distance D of a distance profile—is chosen such that the electrically conductive layer 17 acts as a useful reflector for the antenna 12. In particular, the antenna 12 emits/receives both (i) radio waves W from/to its front side 19 that faces the front side 5 of the housing 4 and (ii) radio waves W′ from/to its rear side 20 that faces the solar cell 13. The latter radio waves W′ are reflected by the electrically conductive layer 17 and redirected as reflections to the antenna 12. The reflected radio waves W′ interfere at the antenna 12 with the radio waves W in constructive interference when the distance D is about half the wavelength λ of the center frequency of the frequency bands of the radio waves W, W′, or any integer multiple thereof. More specifically, for constructive interference the distance D is chosen such that

2·D=n·λ(n=1, 2, 3, . . . )±δ,

with λ in the range of 0≤δ<λ/3.

Alternatively, the reflected radio waves W′ interfere at the antenna 12 with the radio waves W in destructive interference when the distance D is outside of the above ranges.

The front side 5 of the housing 4 may be provided with one or more adhesive strips or suction cups 21 for attachment to, e.g., the inside of a windscreen of a vehicle. The front side 5 will then be directed—through the windscreen—outwards, towards the system 3, whereas the rear side 6 with the photosensitive side 15 of the solar cell 13 will face the vehicle's interior to gather ambient light there.

The disclosed subject matter is not restricted to the specific embodiments described in detail herein but encompasses all variants, modifications and combinations thereof which fall into the scope of the appended claims.

1. An onboard unit for wireless communication with a vehicle identification system via radio waves, comprising:
a housing with a front side and a rear side,
a circuit board in the housing,
an antenna for radio waves which is connected to the circuit board and arranged in the housing near the front side, and
a solar cell supported by the housing near the rear side, powering the circuit board and having a photosensitive side and an electrically conductive layer, the photosensitive side being visible from outside the housing,
wherein the antenna is arranged at a distance from the electrically conductive layer of the solar cell such that radio waves penetrating the front side interfere at the antenna with radio waves reflected by the electrically conductive layer.

2. The onboard unit according to claim 1, wherein the distance is an integer multiple of half the wavelength of a center frequency of the radio waves.

3. The onboard unit according to claim 1, wherein the electrically conductive layer of the solar cell faces the antenna.

4. The onboard unit according to claim 1, wherein the antenna is a patch antenna which is parallel to the electrically conductive layer.

5. The onboard unit according to claim 1, wherein the front side is provided with an adhesive strip or a suction cup for attaching the housing to a windscreen of a vehicle.
